(19) United States
(12) Patent Application Publication
(10) Pub. No.: US 2026/0289388 A1
(43) Pub. Date: Sep. 24, 2026

(54) ESTIMATING AN EVALUATION OF A USER OF A SENSED PERSON

(71) Applicant: CORSIGHT A.I., Tel Aviv (IL)

(72) Inventors: Shai Toren, Timrat (IL); Matan Noga, Tel Aviv (IL)

(73) Assignee: CORSIGHT A.I., Tel Aviv (IL)

(21) Appl. No.: 19/084,584

(22) Filed: Mar. 19, 2025

(51) Int. Cl. G06N 20/00

(52) U.S. Cl. CPC G06N 20/00

(57) ABSTRACT

A method for estimating an evaluation of a user of a sensed person, the method includes (a) receiving, by a hardware processing circuit, sensed person information that is sensed by a sensing unit and at least partially represents the sensed person; (b) generating, by the hardware processing circuit, using a representation generation process, a sensed person representation; (c) comparing the sensed person representation to a user subjective evaluation representation that maps sensed information to a subjective perception of the user of a subjective quality of a person when the user is presented with the sensed information; (d) determining, based on the comparing, a subjective perception of the user of the human subjective quality of the sensed person; and (e) storing in a memory unit an outcome of the determining.

### BACKGROUND

Human beings often form subjective impressions of others based on their appearance, voice, and body language. For example, a person might intuitively judge whether someone appears trustworthy, confident, a leader, or attractive. These judgments are influenced by individual preferences and biases, making them difficult to quantify or standardize.

Existing systems for candidate evaluation, such as in recruitment, matchmaking, or social platforms, as well as many Marketing campaigns often rely on predefined, objective parameters that may not capture subjective human preferences.

There is a growing need to estimate an evaluation of a user of a sensed person.

### SUMMARY

There is provided a method, a non-transitory computer readable medium and a system as illustrated in the application.

### BRIEF DESCRIPTION OF THE DRAWINGS

The embodiments of the disclosure will be understood and appreciated more fully from the following detailed description, taken in conjunction with the drawings in which:

FIG. 1 illustrates an example of a computerized system;

FIG. 2 illustrates an example of a method;

FIG. 3 illustrates an example of method;

FIG. 4 illustrates an example of a training process;

FIG. 5 illustrates an example of an inference process;

FIG. 6 illustrates an example of a method; and

FIG. 7 illustrates an example of method.

### DETAILED DESCRIPTION

The different figures illustrates examples of units and/or software and/or information items and/or steps and/or components. These examples are provided for brevity of explanation. At least one of the units and/or software and/or information items and/or steps and/or components is optional or mandatory.

The term obtaining include receiving and/or generating.

Artificial intelligence is used in relation to machines that mimic human intelligence and human cognitive functions like learning and problem solving. There are three types of artificial intelligence that include artificial super intelligence, artificial narrow intelligence, and artificial general intelligence. Machine learning is a subset of artificial intelligence that allows for optimization. Deep machine learning is a subset of machine learning that uses larger datasets for training and learns in a different manner than not deep machine learning. Neural networks are a subset of machine learning and are used for implementing deep learning.

Any reference in the application to any of the terms “artificial intelligence”, “machine learning”, “deep learning” or “neural network” should be applied mutatis mutandis to any other term of “artificial intelligence”, “machine learning”, “deep learning” or “neural network”. For example-any reference to a neural network should be applied mutatis mutandis to artificial intelligence and/or should be applied mutatis mutandis to “machine learning”, and/or should be applied mutatis mutandis to “deep learning”.

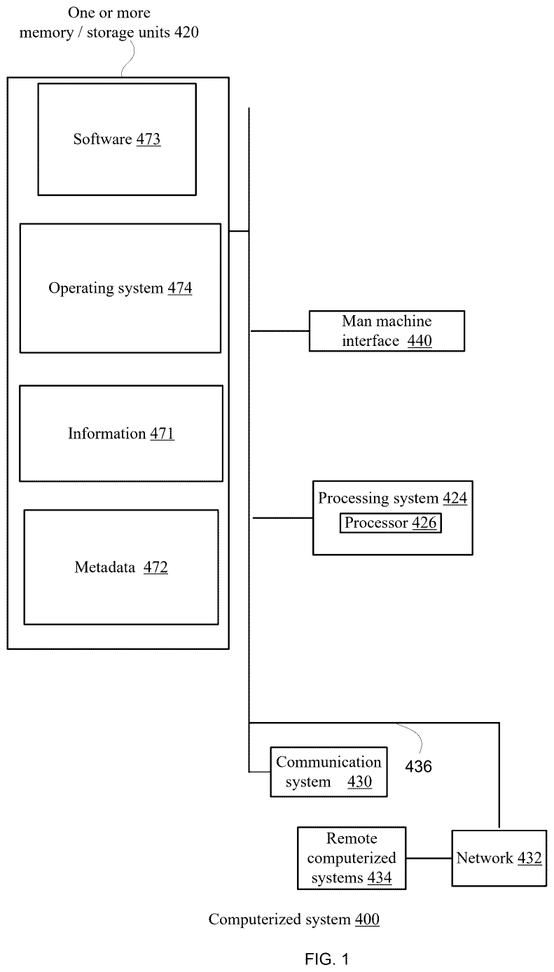

FIG. 1 illustrates an example of a computerized system 400 used to implement method 10 and/or method 100.

Computerized system 400 includes a man machine interface 440 having or being in communication with man machine interface (MMI) controller (not shown), a communication system 430, one or more memory and/or storage units 420, a processing system 424 including processor 426. The computerized system may be a server, a laptop, a desktop, or any other computer and may include or be in communication with a sensing unit and/or a controller.

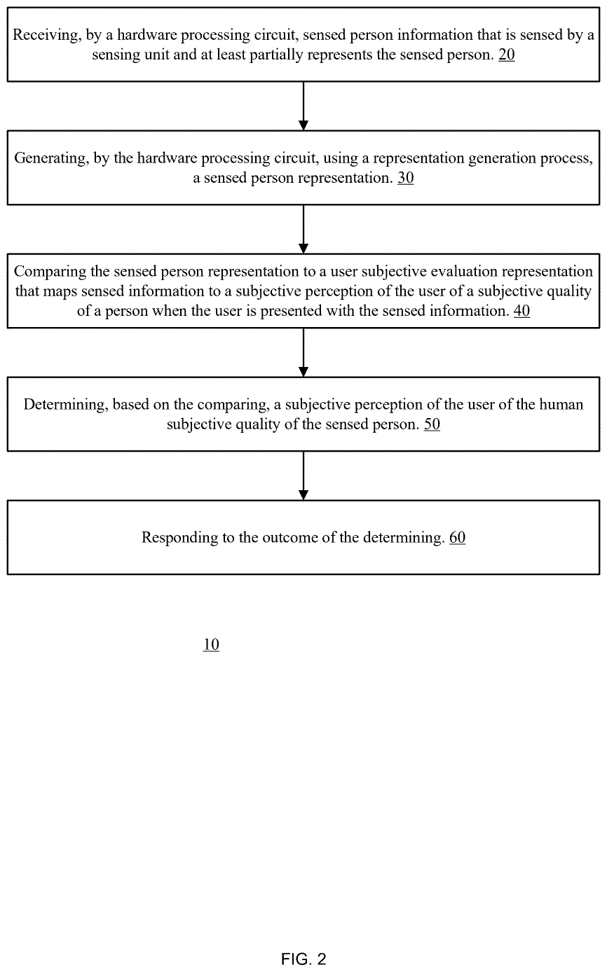

According to an embodiment, computerized system 400 is in communication with network 432 and one or more other remote computerized systems 434 that are in communication with network 432. An example of a remote computerized system is a vehicle (such as vehicle 300 of FIG. 2), a server or one or more computers having access to a storage system.

The memory and/or storage units 420 was shown as storing software. Any reference to software should be applied mutatis mutandis to code and/or firmware and/or instructions and/or commands, and the like.

Processor 426 includes a plurality of processing units 426(1)-426(J), J is an integer that exceeds one. Any reference to one unit or item should be applied mutatis mutandis to multiple units or items. For example-any reference to processor should be applied mutatis mutandis to multiple processors, any reference to communication system 430 should be applied mutatis mutandis to multiple communication systems.

According to an embodiment, the memory and/or storage units 420 stores at least one of: operating system 474, information 471, metadata 472, and software 473.

According to an embodiment, processing system 424 is configured to perform method 10 and/or method 100 while executing software.

FIG. 2 illustrates an example of method 10 for estimating an evaluation of a user of a sensed person.

According to an embodiment, method 10 includes step 20 of receiving, by a hardware processing circuit, sensed person information that is sensed by a sensing unit and at least partially represents the sensed person.

According to an embodiment, the sensed person information captures the entire sensed person or captures only one or more parts of the person—without capturing the entire sensed person.

According to an embodiment, the sensed person information provides a full description of the person (for example a color audio visual video of the person or a color image of the person) or may only provide partial information about the person (for example a monochromatic image, a partially blurred image, an audio recording of the person, and the like).

According to an embodiment, what amount to full or partial information is defined in any manner and/or by any entity.

According to an embodiment, what amount to full or partial information is context specific—for example based on the type of information required during inference-for example, a teacher may be provided with visual and audio information in order to evaluate its response to the voice and appearance of her students.

According to an embodiment, the sensed information includes smells.

According to an embodiment, step 20 is followed by step 30 of generating, by the hardware processing circuit, using a representation generation process, a sensed person representation.

According to an embodiment, step 30 is followed by step 40 of comparing the sensed person representation to a user subjective evaluation representation that maps sensed information to a subjective perception of the user of a subjective quality of a person when the user is presented with the sensed information.

According to an embodiment, the sensed person representation and the user subjective evaluation representation are embeddings.

According to an embodiment, step 40 is followed by step 50 of determining, based on the comparing, a subjective perception of the user of the human subjective quality of the sensed person.

According to an embodiment, step 50 is based on the assumption that sensed person information that is similar to sensed person of the dataset will receive similar subjective perception of the user to the human subjective quality that was provided by the feedback of the user when presented with the sensed information of the dataset.

According to an embodiment, the training of the machine learning process is a supervised training.

According to an embodiment, step 50 is following by step 60 of responding to the outcome of the determining.

According to an embodiment, the responding includes at least one of storing in a memory unit an outcome of the determining, transmitting the outcome, access protecting the outcome, verifying and/or testing the outcome, and the like.

According to an embodiment, multiple subjective qualities are tested—for example are independently tested. According to an embodiment, for each subjective quality of a plurality of subjective qualities, the step 40 is executed, whereas different subjective qualities are associated with different user subjective evaluation representations—different user subjective evaluation representations map sensed information to a subjective perception of the user of different subjective qualities of a person when the user is presented with the sensed information. The different user subjective evaluation representations may be trained at different training process or a single training process in which the feedback of the user is related to different subjective qualities.

According to an embodiment, the user subjective evaluation representation is generated by applying machine learning process that is trained using feedback from the user regarding subjective perception of the user when presented with a training dataset.

According to an embodiment, the machine learning process is trained to associate between a set of training dataset persons representations generated by the representation generation process, and the feedback.

According to an embodiment, the machine learning process is configured, following the training, to estimate the subjective perception of the user of the human subjective quality of a sensed person when presented with the sensed person information.

According to an embodiment, the user subjective evaluation representation includes one or more embeddings.

According to an embodiment a set of embeddings that is associated with the set of training dataset persons representations are converted to a single embedding that is the user subjective evaluation representation.

According to an embodiment, the conversion includes averaging or a weighted sum.

According to an embodiment, the averaging includes mean pooling.

According to an embodiment, the averaging includes computing the element-wise mean of all N embeddings—for example—Efinal=N1i=1ΣNei

The averaging is fast, simple, and works well when embeddings are similar. On the other hand, the averaging may not capture variations well when embeddings are diverse.

According to an embodiment, the conversion includes performing Principal Component Analysis (PCA).

According to an embodiment, the performing of the PCA includes Apply PCA on the set of N embeddings and keep the first principal component.

This captures the most significant variation across the embeddings while reducing dimensionality.

According to an embodiment, the performing of the PCA includes:
Stacking all N embeddings into a matrix M.
Computing the principal components.
Taking the first principal component as the final compressed embedding.

The applying of the PCA retains the most significant variance while reducing dimensionality but may be computationally expensive for large values of N.

According to an embodiment, the converting includes Autoencoder-based Fusion.

According to an embodiment, the autoencoder-based fusion includes
Training an autoencoder (encoder-decoder neural network) to learn a compact representation of the set of embeddings.
Inputting to the encoder multiple embeddings and producing by the encoder a single compressed vector.

According to an embodiment, the autoencoder-based fusion includes:
Train an autoencoder on face embeddings.
Encode N embeddings into a shared latent space.
Take the latent representation as the final compressed embedding.

The autoencoder-based fusion captures non-linear relationships and variation.

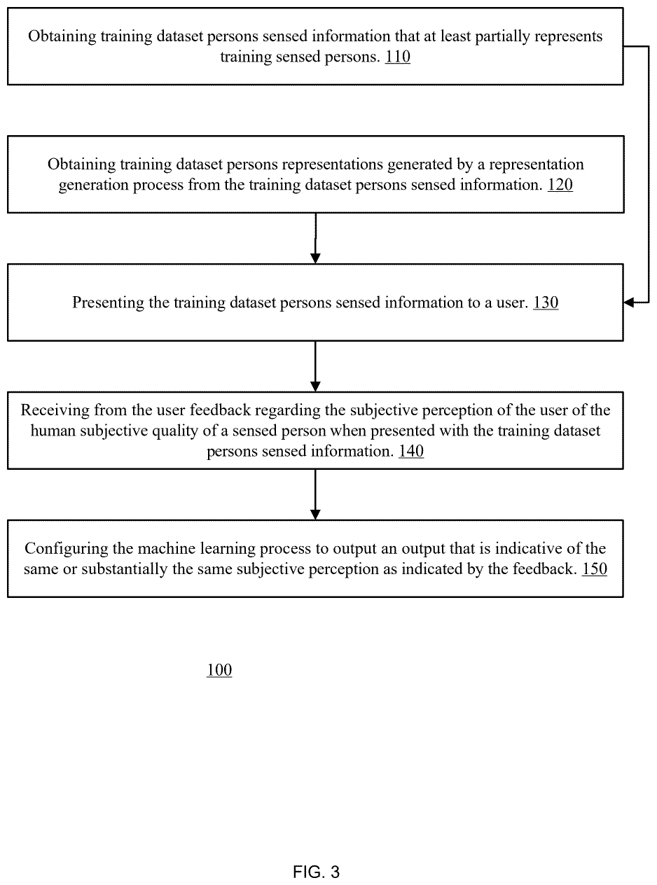

FIG. 3 illustrates an example of a method 100 of training a machine learning process to provide a user subjective evaluation representation.

Method 100 may be applicable to a single subjective quality or to multiple subjective qualities. When associated with multiple subjective qualities—then one or more iterations if the steps of method 100 may be required—at least one subjective quality is covered” by each iteration.

According to an embodiment, the subjective quality is selected or defined by the user, or by other entity. According to an embodiment, the subjective quality is associated with an identifier (for example—leadership, trustworthiness, attractive) that is eligible to any party—or may be associated with an identifier that is ineligible (for example a reference number) to third parties. According to an embodiment the feedback from the user should relate to any evaluated subjective quality.

According to an embodiment, method 100 includes selecting by the user or presenting to the user with a subjective quality that should be evaluated.

According to an embodiment method 100 includes step 110 of obtaining training dataset persons sensed information that at least partially represents training sensed persons.

According to an embodiment method 100 includes step 120 of obtaining training dataset persons representations generated by a representation generation process from the training dataset persons sensed information.

According to an embodiment steps 110 and 120 are followed by step 130 of presenting the training dataset persons sensed information to a user.

According to an embodiment, the order of the presentation (selection of the training dataset persons send information) is made in any manner—random, pseudo-random, based on clusters of representations of training dataset persons, and the like.

Examples of cluster based order of representation may include:
Intra-cluster order—sensed information related to sensed information of the same cluster (clustered based on the representations of the persons) is displayed before presenting sensed information related to sensed information of another cluster.
Inter-cluster order—sensed information related to sensed information of the same cluster is interleaved with sensed information from other clusters displayed before presenting sensed information related to sensed information of other cluster.
Random (or pseudo-random) selection of cluster and within this cluster—presenting the sensed information according to a defined order.
Defined selection of cluster and within this cluster—presenting the sensed information in a random (or pseudo-random) manner.
Random (or pseudo-random) selection of cluster and within this cluster and within this cluster—presenting the sensed information in a random (or pseudo-random) manner.

According to an embodiment step 130 is followed by step 140 of receiving from the user feedback regarding the subjective perception of the user of the human subjective quality of a sensed person when presented with the training dataset persons sensed information.

According to an embodiment, the feedback provided by the user is binary (yes or no) or may be n-ary (wherein n exceeds two).

According to an embodiment the feedback reflects a user perception of how closely each candidate embodies the subjective quality.

According to an embodiment, the feedback is a relativistic feedback-the user may indicate the relationship between the subjective quality of one sensed person to another, may rank the sensed persons in relation to the subjective quality, and the like.

According to an embodiment step 140 is followed by step 150 of configuring the machine learning process to output an output that is indicative of the same or substantially the same subjective perception as indicated by the feedback. Step 150 may include using a loss function, backpropagation, and the like.

According to an embodiment, the user subjective evaluation representation is generated by applying machine learning process that is trained using feedback from the user regarding subjective perception of the user when presented with a training dataset.

According to an embodiment, the machine learning process is trained to associate between a set of training dataset persons representations generated by the representation generation process, and the feedback.

According to an embodiment, the machine learning process is configured, following the training, to estimate the subjective perception of the user of the human subjective quality of a sensed person when presented with the sensed person information.

According to an embodiment, the user subjective evaluation representation includes one or more embeddings.

According to an embodiment a set of embeddings that is associated with the set of training dataset persons representations are converted to a single embedding that is the user subjective evaluation representation.

According to an embodiment, once the user completes the evaluation, the method aggregates the feedback using the machine learning process to generate a reduced embedding or concept vector. This embedding represents the essence of the quality based on the user's subjective evaluations. According to an embodiment, the embedding combines high-ranked candidates to form a personalized representation of the desired quality.

According to an embodiment, method 100 (or at least steps 120-150) are repeated-to allow the user to change his feedback, refine the machine learning process and/or the user subjective evaluation representation, and the like.

According to an embodiment, method 100 may also include new sensed person information regarding new sensed person from which feedback from the user should be provided—in order to refine the machine learning process and/or the user subjective evaluation representation, and the like.

According to an embodiment, method 100 may also be executed for allowing the user to reevaluate his feedback regarding one or more sensed persons.

According to an embodiment, the suggested solution may be applicable to multiple fields such as but not limited to:
Recruitment and Talent Acquisition: Identifying candidates who embody qualities such as leadership or trustworthiness. The system may also warn the user that a certain individual is one the user is prone to have bias for or against, i.e.—the distance between the candidate's embedding and the quality reduced embedding is large (low similarity). This approach can also increase fairness.
Matchmaking Platforms: Personalizing recommendations based on subjective perceptions of attractiveness or compatibility with selected “qualities.”
Entertainment and Media: Casting actors or performers who embody specific traits, such as playfulness or charisma.
Retail and Marketing: Selecting brand ambassadors who align with desired brand values, such as trust or professionalism and/or Salesmen who project certain qualities.
Politics: Help direct politicians with Hairstyle, speech tone and or style, pose, dress style etc.
Communication: some concepts that are hard to explain with words can be simplified and become tangible with the system. It could assist in communication with people with certain disabilities such autism (finding the right aid). Some concepts that are difficult to articulate can be simplified and made tangible with the system. It could assist in communicating with people who have certain disabilities, such as autism, by overriding the stage of explaining emotions/triggers and simplifying it to yes/no over a range of candidates.

According to an embodiment, the suggested solution exhibits at least the following benefits:
Expressability: the solution provides a representation of something that often cannot be easily expressed with words.
Personalization: the solution allows for individualized definitions of abstract qualities, ensuring tailored results.
Adaptability: the reduced embedding can evolve with user input, making the system dynamic and responsive to changing preferences.
Enhanced Decision-Making: by combining subjective input with machine learning, the system provides a robust mechanism for identifying candidates who align with nuanced human perceptions. . Wide Applicability: the methodology is flexible, and can be applied across industries and use cases.

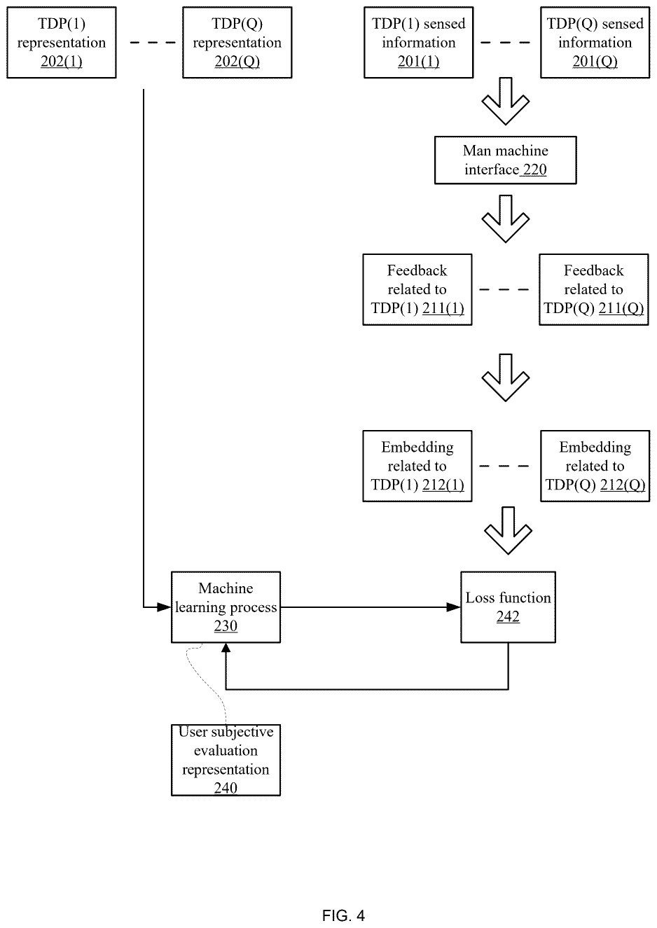

FIG. 4 illustrates an example of a training process.

Multiple training dataset sensed persons sensed information 201(1)-201(Q), and multiple training dataset sensed persons representations 202(1)-202(Q), are provided. The multiple training dataset sensed persons sensed information 201(1)-201(Q) are presented to the user (using man machine interface 220) to provide feedback (211(1)-211(Q) related to the training dataset sensed persons that ae converted to embeddings 212(1)-212(Q), used for training machine learning process 230 using a loss function 240—so that the machine learning process implements (or represents) a user subjective evaluation representation 240.

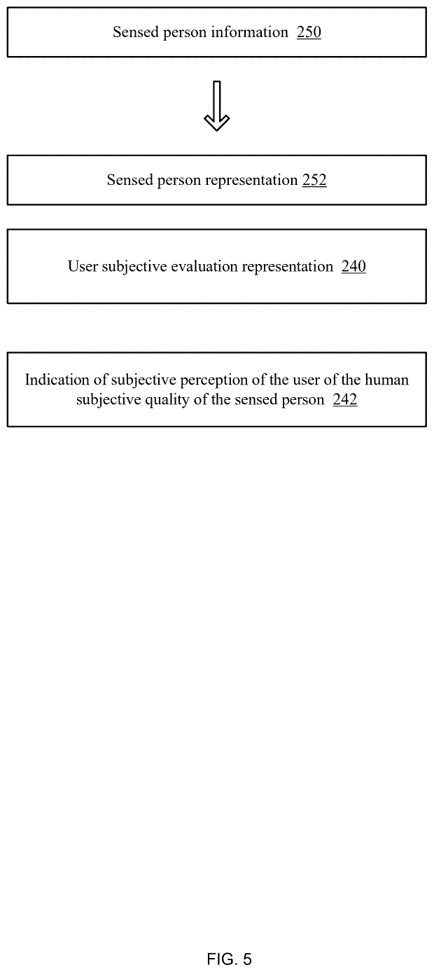

FIG. 5 illustrates an example of an inference process and illustrates sensed person information 250 (to be processed during inference), sensed person representation 252 compared to User subjective evaluation representation 240 to provide an indication of subjective perception of the user of the human subjective quality of the sensed person 242.

According to an embodiment, the user subjective evaluation process is generated without using a machine learning process and/or without training a machine learning process.

According to an embodiment the generating of the user subjective evaluation process and/or the inference is executed in part by a face recognition module (even an off the shelf face recognition module) that converts an image to an embedding.

According to an embodiment, the user subjective evaluation representation is generated by obtaining representations of top sensed persons that exhibit highest associations with the subjective quality according to feedback received from the user during training; and converting the representations of top sensed persons to the user subjective evaluation representation.

According to an embodiment, method 100 also includes generating the user subjective evaluation representation by: obtaining representations of top sensed persons that exhibit highest associations with the subjective quality according to feedback received from the user during training; and converting the representations of top sensed persons to the user subjective evaluation representation.

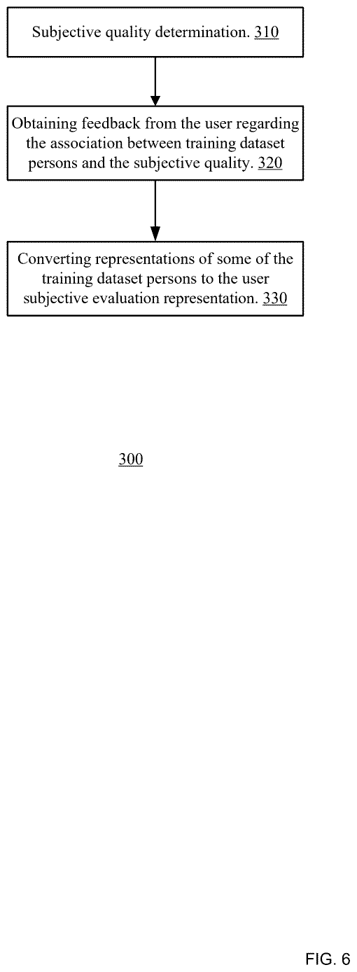

FIG. 6 illustrates an example of method 300 for generating the user subjective evaluation representation.

According to an embodiment, method 300 includes:
Step 310 of determining (for example selecting by the user) a subjective quality to be evaluated.
Step 320 of obtaining feedback from the user regarding the association between training dataset persons and the subjective quality.
Step 330 of converting representations of some of the training dataset persons to the user subjective evaluation representation. The representations may be embeddings, and the converting may include generating a single embedding of the embeddings of at least some of the training dataset persons.

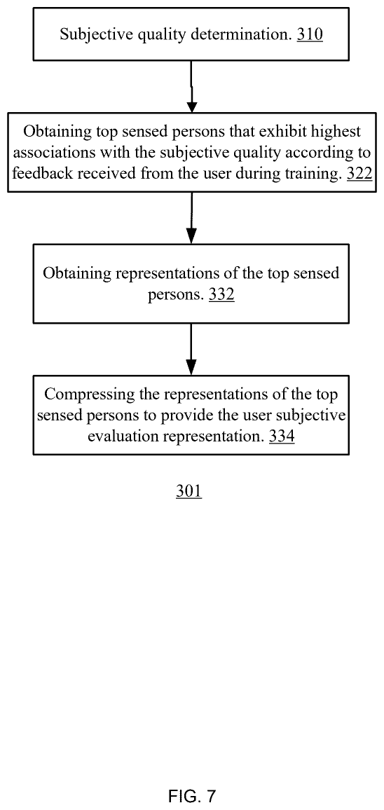

FIG. 7 illustrates an example of method 301 for generating the user subjective evaluation representation.

According to an embodiment, method 301 includes:
Step 310 of determining (for example selecting by the user) a subjective quality to be evaluated.
Step 322 of obtaining top sensed persons that exhibit highest associations with the subjective quality according to feedback received from the user during training.
Step 332 of obtaining representations of the top sensed persons.
Step 334 of compressing the representations of the top sensed persons to provide the user subjective evaluation representation.

According to an embodiment, steps 330 and/or 334 include at least one of averaging, performing of the PCA, or Autoencoder-based Fusion.

Any reference to any one of the terms “comprise”, “comprises”, “comprising”, “include”, “including”, “includes”, “having” should be applied mutatis mutandis to “consisting” or “consists”. For example—any of the mentioned above may be limited only to steps explicitly illustrated as part of the method.

Any reference to any one of the terms “comprise”, “comprises”, “comprising”, “include”, “including”, “includes”, “having” should be applied mutatis mutandis to “consisting essentially of” or “consists essentially of”.

The term obtaining include receiving and/or generating.

Because some aspects of the illustrated embodiments of the present disclosure may, for the most part, be implemented using electronic components and circuits known to those skilled in the art, details will not be explained in any greater extent than that considered necessary as illustrated above, for the understanding and appreciation of the underlying concepts of the present invention and in order not to obfuscate or distract from the teachings of the present invention.

Any combination of any steps of any method illustrated in the specification and/or drawings may be provided. Any combination of any subject matter of any of claims may be provided. Any combinations of systems, units, components, processors, sensors, illustrated in the specification and/or drawings may be provided. Any combination of any module or unit listed in any of the figures, any part of the specification and/or any claims may be provided.

Any reference in the specification to a method should be applied mutatis mutandis to a device or system capable of executing the method and/or to a non-transitory computer readable medium that stores instructions for executing the method. Any reference in the specification to a system or device should be applied mutatis mutandis to a method that may be executed by the system, and/or may be applied mutatis mutandis to non-transitory computer readable medium that stores instructions executable by the system.

Any reference in the specification to a non-transitory computer readable medium should be applied mutatis mutandis to a device or system capable of executing instructions stored in the non-transitory computer readable medium and/or may be applied mutatis mutandis to a method for executing the instructions.

In the foregoing specification, the invention has been described with reference to specific examples of embodiments of the invention. It will, however, be evident that various modifications and changes may be made therein without departing from the broader spirit and scope of the invention as set forth in the appended claims. The specifications and drawings are, accordingly, to be regarded in an illustrative rather than in a restrictive sense.

Those skilled in the art will recognize that the boundaries between logic blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures may be implemented which achieve the same functionality.

Those skilled in the art will recognize that boundaries between the above-described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

Any arrangement of components to achieve the same functionality is effectively “associated” such that the desired functionality is achieved. Hence, any two components herein combined to achieve a particular functionality may be seen as “associated with” each other such that the desired functionality is achieved, irrespective of the underlying architecture or intermedial components. Likewise, any two components so associated can also be viewed as being “operably connected,” or “operably coupled,” to each other to achieve the desired functionality.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

It is appreciated that various features of the embodiments of the disclosure which are, for clarity, described in the contexts of separate embodiments may also be provided in combination in a single embodiment. Conversely, various features of the embodiments of the disclosure which are, for brevity, described in the context of a single embodiment may also be provided separately or in any suitable sub-combination.

It will be appreciated by persons skilled in the art that the embodiments of the disclosure are not limited by what has been particularly shown and described hereinabove. Thus, the scope of the embodiments of the disclosure is defined by the appended claims and equivalents thereof. While certain features of the disclosure have been illustrated and described herein, many modifications, substitutions, changes, and equivalents will now occur to those of ordinary skill in the art. It is therefore to be understood that the appended claims are intended to cover all such modifications and changes as fall within the true spirit of the invention.

We claim

1. A method for estimating an evaluation of a user of a sensed person, the method comprises:
receiving, by a hardware processing circuit, sensed person information that is sensed by a sensing unit and at least partially represents the sensed person;
generating, by the hardware processing circuit, using a representation generation process, a sensed person representation;
comparing the sensed person representation to a user subjective evaluation representation that maps sensed information to a subjective perception of the user of a subjective quality of a person when the user is presented with the sensed information;
determining, based on the comparing, a subjective perception of the user of the human subjective quality of the sensed person; and
storing in a memory unit an outcome of the determining.

2. The method according to claim 1, wherein the sensed person representation and the user subjective evaluation representation are embeddings.

3. The method according to claim 1, wherein the user subjective evaluation representation is generated by applying machine learning process that is trained using feedback from the user regarding subjective perception of the user when presented with a training dataset.

4. The method according to claim 3, wherein the machine learning process is trained to associate between a set of training dataset persons representations generated by the representation generation process, and the feedback.

5. The method according to claim 1, wherein the sensed person representation is at least one of visual sensed information and audio sensed information.

6. The method according to claim 1, wherein the sensed person representation represents smell information regarding the sensed person.

7. The method according to claim 1, wherein the user subjective evaluation representation is generated by:
obtaining representations of top sensed persons that exhibit highest associations with the subjective quality according to feedback received from the user during training; and converting the representations of top sensed persons to the user subjective evaluation representation.

8. The method according to claim 1, comprising generating the user subjective evaluation representation by:
obtaining representations of top sensed persons that exhibit highest associations with the subjective quality according to feedback received from the user during training; and
converting the representations of top sensed persons to the user subjective evaluation representation.

9. A non-transitory computer readable medium for estimating an evaluation of a user of a sensed person, the non-transitory computer readable medium stores instructions that, when executable by a hardware processing circuit of a computerized system, cause the computerized system to:
receive sensed person information that is sensed by a sensing unit and at least partially represents the sensed person;
generate, using a representation generation process, a sensed person representation;
compare the sensed person representation to a user subjective evaluation representation that maps sensed information to a subjective perception of the user of a subjective quality of a person when the user is presented with the sensed information;
determine, based on the comparing, a subjective perception of the user of the human subjective quality of the sensed person; and
store in a memory unit an outcome of the determining.

10. The non-transitory computer readable medium according to claim 9, wherein the sensed person representation and the user subjective evaluation representation are embeddings.

11. The non-transitory computer readable medium according to claim 9, wherein the user subjective evaluation representation is generated by applying machine learning process that is trained using feedback from the user regarding subjective perception of the user when presented with a training dataset.

12. The non-transitory computer readable medium according to claim 9, wherein the machine learning process is trained to associate between a set of training dataset persons representations generated by the representation generation process, and the feedback.

13. The non-transitory computer readable medium according to claim 9, wherein the sensed person representation is at least one of visual sensed information and audio sensed information.

14. The non-transitory computer readable medium according to claim 9, wherein the sensed person representation represents smell information regarding the sensed person.

15. The non-transitory computer readable medium according to claim 9, wherein the user subjective evaluation representation is generated by:
obtaining representations of top sensed persons that exhibit highest associations with the subjective quality according to feedback received from the user during training; and converting the representations of top sensed persons to the user subjective evaluation representation.

16. The non-transitory computer readable medium according to claim 9, wherein the non-transitory computer readable medium stores instructions that, when executable by the hardware processing circuit, cause the computerized system to generate the user subjective evaluation representation by:
obtaining representations of top sensed persons that exhibit highest associations with the subjective quality according to feedback received from the user during training; and
converting the representations of top sensed persons to the user subjective evaluation representation.

17. A computerized system for estimating an evaluation of a user of a sensed person, the computerized system comprises a hardware processing circuit that is configured to:
receive sensed person information that is sensed by a sensing unit and at least partially represents the sensed person;
generate, using a representation generation process, a sensed person representation;
compare the sensed person representation to a user subjective evaluation representation that maps sensed information to a subjective perception of the user of a subjective quality of a person when the user is presented with the sensed information;
determine, based on the comparing, a subjective perception of the user of the human subjective quality of the sensed person; and
store in a memory unit an outcome of the determining.

18. The computerized system according to claim 17, wherein the sensed person representation and the user subjective evaluation representation are embeddings.

19. The computerized system according to claim 17, wherein the user subjective evaluation representation is generated by applying machine learning process that is trained using feedback from the user regarding subjective perception of the user when presented with a training dataset.

20. The computerized system according to claim 17, wherein the user subjective evaluation representation is generated by:
obtaining representations of top sensed persons that exhibit highest associations with the subjective quality according to feedback received from the user during training; and
converting the representations of top sensed persons to the user subjective evaluation representation.
